(19) United States
(12) Patent Application Publication
(10) Pub. No.: US 2015/0122479 A1
(43) Pub. Date: May 7, 2015

(54) TIME OF FLIGHT THROUGH MUD

(71) Applicant: Piezotech, LLC, Indianapolis, IN (US)

(72) Inventor: Gregory Pulley, Berthoud, CO (US)

(21) Appl. No.: 14/533,546

(22) Filed: Nov. 5, 2014

Related U.S. Application Data
(60) Provisional application No. 61/900,063, filed on Nov. 5, 2013.

(51) Int. Cl. E21B 47/18; E21B 47/01; G01S 15/02

(52) U.S. Cl. CPC E21B 47/18; G01S 15/02; E21B 47/01
USPC 166/66

(57) ABSTRACT

Among other things, there are disclosed embodiments of devices, suitable for incorporation into well-logging tools, for the in situ measurement of the acoustic impedance of a fluid in the well bore, such as drilling mud. The device includes a sonic emitter that emits sonic pulses into a solid probe. The pulses are partially transmitted and partially reflected at opposite surfaces, and the decay of the amplitude of successive sonic pulses is used to determine the acoustic impedance of the fluid.

### PRIORITY CLAIM

This application claims priority from U.S. Provisional Patent Application No. 61/900,063, filed Nov. 5, 2013.

The present disclosure relates to inspection of the acoustic impedance of an external medium. More particularly, the disclosure relates to tools and methods for in situ measurement of the acoustic impedance of drilling mud or other fluid in a well bore.

### BACKGROUND

Acoustic inspection is a recognized technology for investigating the down-hole environment in well bores, in both open- and cased-hole environments. Acoustics have been used to investigate cement bond quality for decades (see, e.g., U.S. Pat. No. 4,255,798). A variety of acoustic methods for inspecting the downhole environment have been developed, including methods that operate by measuring the speed of different types of sound waves (e.g. longitudinal waves or shear waves). These techniques are used for a variety of purposes, including, in the context of open holes, to inspect the surrounding formation to determine its porosity and mechanical integrity (such as a tendency to “sand”), and, in the context of cased holes, to determine the integrity of the casing and the quality of the cement bond behind the casing.

The well bore may be filled with a variety of different types of fluid. In cased wells, this may be brine or other lighter fluids. Open holes are typically maintained in approximately hydrostatic equilibrium to prevent collapse by filling them with heavier fluids. The weighted fluid that is typically used to achieve this is generally referred to as “mud,” but it is actually a carefully engineered fluid that often costs more per barrel than the hydrocarbons that are typically the object of the well. Depending on the demands of the particular drilling project, mud may weigh more than 25 lbs/gals.

Although such fluids are carefully engineered, inhomogeneity in the well bore is always a risk. The fluids circulate throughout the well bore, over a complete circuit miles in length, through a range of pressures and temperatures, at different speeds and a variety of turbulent and laminar flow conditions, carrying debris from the drilling operation. When the drilling operation is suspended to allow logging, therefore, the fluid at a particular portion of a well bore may be substantially different from the ideal.

Sound waves from a logging tool pass through this medium to inspect the environment. Often, the effects of the medium are removed through computer processing based on a model of the sonic properties of the fluid. But the modeled properties of the fluid in some circumstances may not accurately represent the reality in the bore hole. What is needed, therefore, is a means of in situ measurement of the acoustic impedance of drilling mud. Embodiments disclosed herein meet this need.

### SUMMARY

Among other things, there are disclosed embodiments of devices for in situ measurement of the acoustic impedance of a fluid in a well bore. The devices can advantageously be incorporated into a well-logging tool, either by themselves, or in combination with other devices. In certain embodiments, a well-logging tool incorporating such a device comprises an external housing, an electronic controller, an acoustic emitter, an acoustic receiver, and a probe. The acoustic emitter is contained within the housing and is adapted to generate sonic pulses. The probe is substantially cylindrical, and has an interior face and a front face. The sonic pulses enter the probe from the acoustic emitter through the interior face. The sonic pulses travel the length of the probe, are partially transmitted through the front face into the fluid, and are partially reflected back. The portion of the sonic pulses that is reflected back again travels the length of the probe, and is then partially transmitted through the internal face and partially reflected back. The acoustic receiver receives the sonic pulses that return from the probe through the internal face, and generates an echo pulse signal that indicates the amplitude of successive echo pulses. The electronic controller receives the echo pulse signal from the acoustic receiver and determines the acoustic impedance of the fluid.

### BRIEF DESCRIPTION OF THE DRAWINGS

FIG. 1 is an illustration of a typical well logging tool string.

FIG. 2 is an horizontal cross-sectional illustration of a first embodiment device for in situ measurement of the acoustic impedance of a fluid in the well bore.

FIG. 3 is an illustration of a second embodiment device for in situ measurement of the acoustic impedance of a fluid in the well bore, having two probes facing in opposite directions.

FIG. 4 is an illustration of a third embodiment device for in situ measurement of the acoustic impedance of a fluid in the well bore, having a calibration probe for real-time detection and correction of transient variations in the sonic properties of the device.

### DESCRIPTION OF THE ILLUSTRATED EMBODIMENTS

For the purposes of promoting an understanding of the principles of the disclosure, reference will now be made to the embodiment illustrated in the drawings, and specific language will be used to describe the same. It will nevertheless be understood that no limitation of the scope of the claims is thereby intended, and alterations and modifications in the illustrated device, and further applications of the principles of the disclosure as illustrated therein, are herein contemplated as would normally occur to one skilled in the art to which the disclosure relates.

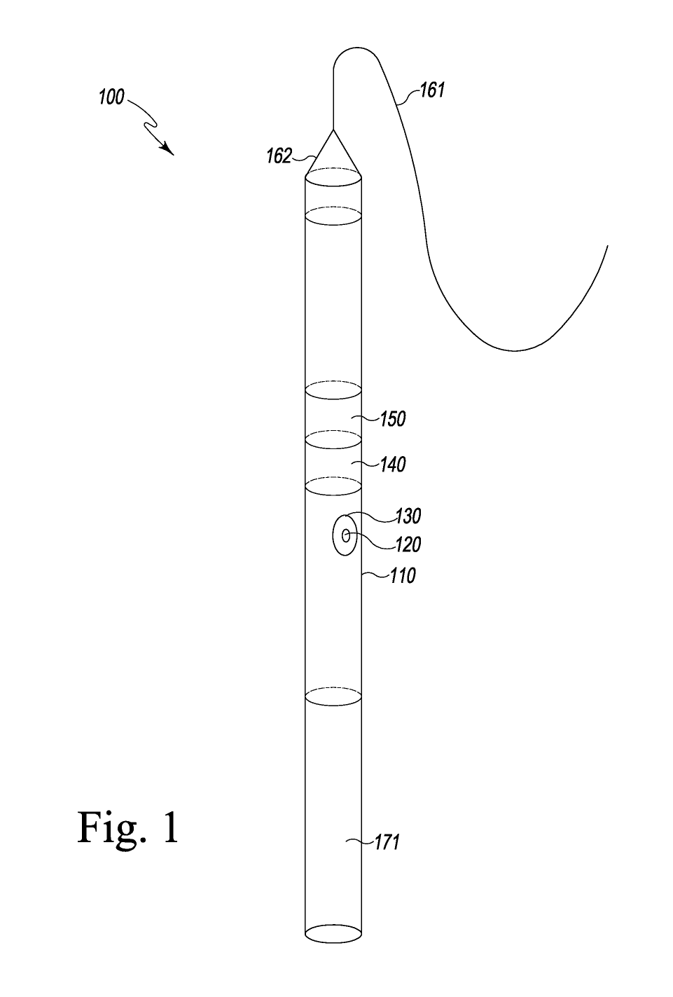

FIG. 1 illustrates a typical well-logging tool, indicated generally at 100, as part of a larger tool string. As will be familiar to those skilled in the art of well logging, the tool 100 is adapted to be inserted into a well bore, and is therefore adapted for insertion into the downhole environment of a well. Because of the physical constraints of the well bore, the housing 110 is typically cylindrical in shape, with a diameter small enough to allow it easy ingress into most or all standard well casing, taking into account the radius of curvature of the well's axis at its tightest points. Thus, the housing is advantageously less than about 6 inches in diameter, and ideally as small as about 2 inches in diameter.

The housing 110 provides pressure and fluid seals at the joints between segments, which protect the internal electronics and power elements from infiltration of fluid and from the pressure of the down-hole environment. The tool 100 is introduced into the well at the end of a wireline cable 161; typically, the wireline cable 161 provides both the mechanical means for lowering and raising the tool in the well and also the electric and/or electronic connection for receiving telemetry from the tool during logging. Typically, the wireline cable 161 is attached to a roughly conical cablehead (or simply “head”) 162, where the tool interfaces with internal wires in the cable 161 to communicate with the surface during logging. The cablehead 162 also typically contains a weak point, which is chosen to assure that it, rather than the cable, breaks if the tool becomes stuck and too much force is applied. The cablehead 162 thus provides both a mechanical and electrical connection with the surface. The cablehead 162 is attached mechanically with the housing 110, typically using both threads, to provide for firm transmission of tension from above, and gaskets, to seal the interior of the housing 110 against external pressure. It will be appreciated, however, that any suitable means of transmitting mechanical force and sealing against pressure may be used. The housing 110 may also optionally be adapted, by threading or other means, for attachment with other well logging tools, such as the tool 171 illustrated in FIG. 1, to form a tool string, to facilitate simultaneous logging of other aspects of the down-hole environment, as will be familiar to those skilled in the art of well logging. In such embodiments, the housing 110 also advantageously contains a shared power supply 150 and bus 160. The bus 160 transmits information from tools in the tool string, including tools below the tool 100, up the string, and then through the head 162 and wireline 161, to allow real-time monitoring during logging.

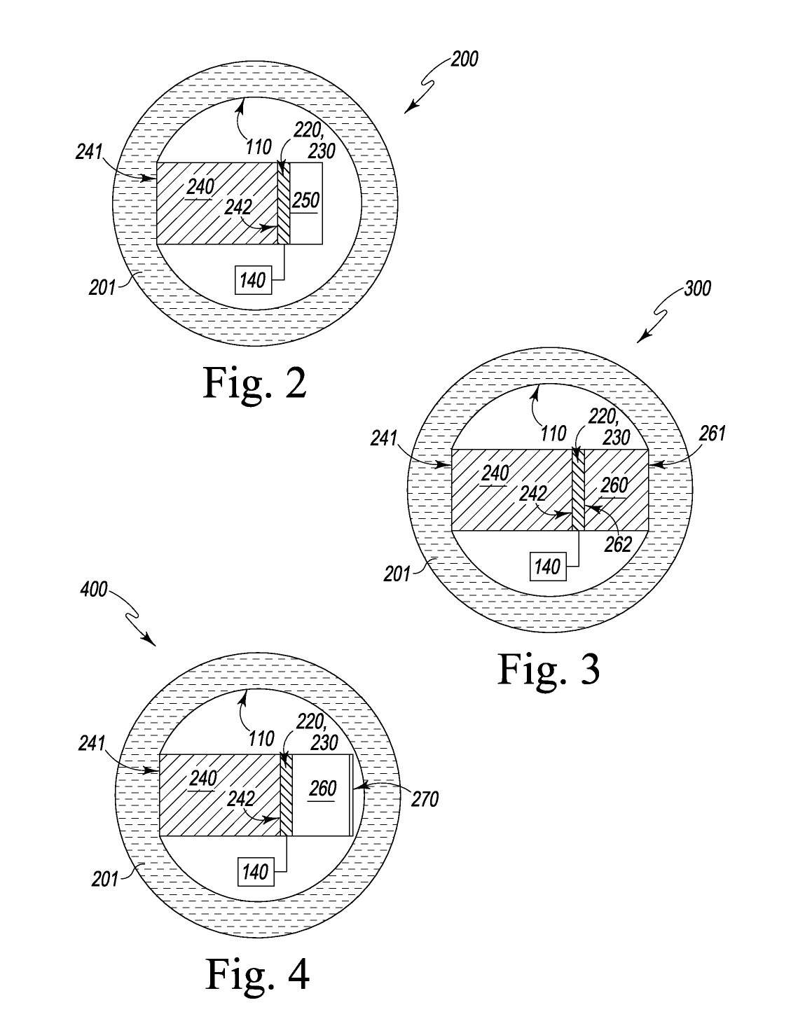

FIG. 2 illustrates a first embodiment of a device for in situ measurement of the acoustic impedance of drilling mud or other well bore fluids, indicated generally at 200. The device 200 is suitable for inclusion in a tool string, either as a separate tool, or as an element of a larger tool. The in situ fluid is indicated at 201. The device 200 comprises an acoustic emitter 220 and acoustic receiver 230 coupled on one side to an intermediate member 240, which shall be referred to herein as a probe 240. The emitter 220 and receiver 230 are typically piezoelectric materials, comprising, but not limited to, piezoelectric crystals, ceramics, polymers, or piezoelectric composite structures. The acoustic emitter 220 and receiver 230 can be separate elements, or, in some embodiments can be a single, rapidly-damping element that both emits and receives. In other embodiments, the emitter 220 and receiver 230 are separate elements cut from a single piezoelectric wafer into an emitter region and a receiver region. (In any case, they, or it, may be contained in a single component, typically referred to as a transducer). An electronic controller 140 causes the emitter 220 to generate trains of acoustic pulses, and receives signals from the receiver 230 indicating the amplitude of reflections from those pulses, as described in greater detail hereinbelow.

The probe 240 conducts acoustic pulses from the emitter 220 to the fluid 201 on the far side of its external face 241. The probe 240 also conducts echo pulses reflected from its internal face 241 back to the receiver 230. The probe 240 is therefore advantageously positioned with its front face 241 substantially aligned with the outside surface of the housing 110 of its tool. In certain embodiments, the probe 240 directly contacts the fluid 201 in the well when the tool 100 is introduced. In other embodiments, the probe 240 is physically separated from the fluid 201, for example by a thin layer of epoxy or other material (not shown), for example to protect the surface from abrasion or other forms of mechanical degradation. In these embodiments, the thin layer advantageously has an acoustic impedance that is the same or nearly the same as the probe 240, in order to minimize or eliminate the effect of the surface at which the probe 240 contacts this layer.

As shown in FIG. 2, in certain embodiments the probe 240 is solid, and is relatively long. In certain embodiments, the probe 240 has a length three times the largest dimension of its front face. In any event, it will be appreciated that the probe 240 has a length that is advantageously chosen to assure that the leading edge of a train of pulses emitted from emitter 220 does not travel the length of the probe 240 and return before the trailing edge of the train is emitted and the receiver 230 is ready to receive. The probe 240 therefore constitutes a delay line. The delay line 240 advantageously has a relatively low speed of sound (at the excitation frequency used), and an acoustic impedance that differs from both the emitter 220 and the acoustic impedance of the fluid 201 (and, in those embodiments with a separate receiver 230, from the receiver 230). In certain embodiments, the length of the probe 240 is at least five times the length of an emitted train of pulses, and is sufficient to allow sufficient temporal separation between successive internal reflections between its front face 241 and its internal face 242, as further discussed hereinbelow. Depending on the physical dimensions of the tool and the acoustic properties of the fluid to be measured, this may mean that the speed of sound in the delay line 140 is less than 5000 m/s; in some embodiments the speed of sound in the delay line is less than 3000 m/s, and in certain embodiments it is less than about 2500 m/s. In certain embodiments the probe 240 is generally cylindrical. In certain alternative embodiments, the probe 240 is substantially conical, frustoconical, or a polygonal crosssection, but having both the front face 241 and the internal face 242 substantially parallel to one another.

In operation, when an acoustic wave passes through the probe's internal face 242, entering the probe 240 from the emitter 220, the pulse propagates through its thickness until it encounters the front face 241. A portion of the acoustic energy is transmitted through the front face 241, into the fluid 201, and a portion is reflected back internally, according to the difference in acoustic impedance between the probe 240 and the fluid 201. The reflected sound waves travel back to the internal face 242, where a portion of the energy is transmitted and a portion is reflected back again. The acoustic pulses reverberate through the probe 240, creating a series of decaying echo pulses transmitted back through the internal face 242, where they are detected by the receiver 230.

The amount of energy reflected at each incidence is:

Eᵣ=E₀(Z₂−Z₁)²/(Z₂+Z₁)² (1)
Where E₀=energy incident on the surface, and
   Z₁ and Z₂=acoustic impedances of the materials on either side of the surface
      Since the proportion of energy transmitted at each surface remains constant for successive echoes, the log of amplitude of the echo series is a straight line, with a slope that is the product of the reflection coefficient at the internal face 242 and the reflection coefficient at the front face 241. The reflection coefficient at the internal face 242 is derived from the specific delay line material properties selected over a range of applicable operating temperatures. The specific acoustic decay characteristics associated with a wellbore fluid can be determined through calibration, by measuring the slope of the pulse energy echo plot with the probe 240 in contact with fluids with known acoustic impedances, such as mineral oils or distilled water. Once the acoustic impedance of the receiver 230 and the probe 240 are known, the acoustic impedance of a fluid 201 can be measured with the slope of the pulse echo energy plot.

It will be appreciated that the fluid 201 is being inspected in situ, in the bore hole. Although bore holes have a variety of sizes, even the smallest of them is several inches in diameter. This uncontained state of the fluid 201 (having minimum free path substantially in excess of the wavelength of the sonic pulses) improves the fidelity of the measurement. It is believed that the measurement accuracy is improved by substantially preventing confounding echos from other surfaces, such as the fluid/casing surface, or from other portions of the surface of the probe 240. In particular, the probe 240 does not surround or contain the fluid being inspected.

FIG. 3 illustrates a second embodiment device for in situ measurement of the acoustic impedance of a fluid 201, indicated generally at 300. The device 300 comprises an acoustic emitter 220, coupled to a first probe 240 and a backing probe 260 that faces in opposite directions. The slope of the pulse echo decays through each of the two probes 240 are averaged to determine an acoustic impedance of the fluid 201.

FIG. 4 illustrates a third embodiment device for in situ measurement of the acoustic impedance of a fluid, 201, indicated generally at 400. The device 400 comprises an acoustic emitter 220, coupled to a first probe 240 and a calibration probe 260. The side of the calibration probe 260 opposite the emitter 220 transmits a portion of the acoustic energy in the pulse trains into a calibration layer 270, rather than the fluid 201. In this way, the response of the emitter 220 and receiver 230 can be calibrated during operation, for example, for transient changes in the acoustic properties of the emitter 220, receiver 230, and probe 240 due to thermal effects, since the acoustic properties of the emitter 220, receiver 230, calibration probe 260, and calibration layer 270 are otherwise constant.

It will be appreciated that the acoustic impedance of the fluid 201 can be used to determine the speed of sound in the fluid from the fluid's density, or vice versa, according to the equation:

Z=ρc (2)

where: ρ=fluid density, and
c=speed of sound in the fluid
   Thus, for example, the speed of sound of the fluid in a specific portion of the well bore can be determined from the acoustic impedance using the density of the fluid.

The United States patent application entitled “High Frequency Inspection of Downhole Environment,” naming Pulley as inventor and filed on the same day as this application, is incorporated herein in its entirety.

While certain embodiments have been illustrated and described in detail in the drawings and foregoing description, the same is to be considered as illustrative and not restrictive in character. All changes and modifications that come within the spirit of the claims are desired to be protected. Features or attributes noted with respect to one or more specific embodiments may be used or incorporated into other embodiments of the structures and methods disclosed.

1. A well-logging tool for in situ measurement of the acoustic impedance of a fluid in a bore hole, the tool comprising:
an external housing;
an acoustic emitter contained within the housing adapted to generate sonic pulses;
an intermediate member having a speed of sound less than 5,000 m/s having an interior face, through which the sonic pulses from the emitter pass, and a front face, which at least partially transmits the sonic pulses into the fluid being measured;
an acoustic receiver that receives successive echo pulses from the probe through the interior face of the probe and generates an echo pulse signal that indicates the amplitude of successive echo pulses;
an electronic controller that receives the echo pulse signal and determines the acoustic impedance of the fluid.

2. The well-logging tool of claim 1, further comprising a second probe that is oriented in the opposite direction, and wherein the electronic controller determines the acoustic impedance of the fluid by averaging the slopes of the decay curves of successive echo pulses in the first and second probes.

3. The well-logging tool of claim 1, wherein the electronic controller determines the speed of sound of the fluid from the acoustic impedance of the fluid.

4. The well-logging tool of claim 1, wherein the member has a speed of sound less than 3000 m/s.

5. The well-logging tool of claim 1, wherein the member has a speed of sound less than 1500 m/s.

6. The well-logging tool of claim 1, wherein the intermediate member is cylindrical.

7. The well-logging tool of claim 1, further comprising a second delay line, and wherein the electronic controller corrects the acoustic impedance of the fluid using the decay curve of successive echo pulses through said second delay line.

8. A well-logging tool for in situ measurement of the acoustic impedance of a fluid in a bore hole, the tool comprising:
an external housing;
a rapid-damping acoustic transceiver contained within the housing and adapted to generate sonic pulses and to receive echo pulses;
a delay line having an interior face, through which the sonic pulses from the emitter pass, and a front face, which at least partially transmits the sonic pulses into the fluid being measured;
wherein the delay line has a length and speed of sound, and the rapid-damping acoustic transceiver, upon emitting a sonic pulse, quiets sufficiently rapidly to cause the sonic pulses that enter the delay line travel the length of the delay line, partially reflect when it reaches the fluid, and return to the interior face to be detected by the transceiver.

9. The well-logging tool of claim 8, wherein the electronic controller determines the speed of sound of the fluid from the sound reflected between the interior face and the front face.

10. The well-logging tool of claim 8, further comprising a second delay line that is oriented in the opposite direction, and wherein the electronic controller determines the acoustic impedance of the fluid by averaging the slopes of the decay curves of successive echo pulses received through said first and second delay lines.

11. The well-logging tool of claim 10, wherein the electronic controller determines the speed of sound of the fluid from the sound reflected between the interior face and the front face.

12. The well-logging tool of claim 8, further comprising an electronic controller that determines the acoustic impedance of the fluid from the slope of the plot of the amplitudes of successive echo pulses.

13. The well-logging tool of claim 12, further comprising a second delay line, wherein the electronic controller corrects the acoustic impedance of the fluid using the slope of the plot of the amplitudes of successive echo pulses in the second delay line.
